(19) United States
(12) Patent Application Publication
(10) Pub. No.: US 2014/0066241 A1
(43) Pub. Date: Mar. 6, 2014

(54) CHAIN BAG FOR A BICYCLE

(71) Applicants: Ting-Wen Huang, Taipei City (TW); Kuo-Yen Huang, Taipei City (TW); Cheng-Hsuan Huang, Taipei City (TW)

(72) Inventors: Ting-Wen Huang, Taipei City (TW); Kuo-Yen Huang, Taipei City (TW); Cheng-Hsuan Huang, Taipei City (TW)

(21) Appl. No.: 13/713,002

(22) Filed: Dec. 13, 2012

(30) Foreign Application Priority Data
Sep. 3, 2012 (TW) 101131998

(51) Int. Cl. B62J 13/04

(52) U.S. Cl. CPC B62J 13/04
USPC 474/146

(57) ABSTRACT

A cover for protecting a drivetrain system, which is used when a bicycle is stowed in a carrying bag, is disclosed. The chain bag is a rectangular bag with two hanging belts. The hanging belts are separately disposed with velcro fasteners for hanging on a frame or rack of a bicycle.

### BACKGROUND OF THE INVENTION

1. Technical Field

The invention relates to bicycles, particularly to bicycle carrying bags.

2. Related Art

In recent years, cycling becomes very popular in the world and can be used for sport, recreation and transportation. Besides cycling in areas near rider's homes, some riders will carry those own bicycles to other distant places or even foreign countries. The best way of carrying a bicycle is to use a main bag. A typical main bag is a zippered nonwoven pouch with handles emerging therefrom.

Stowing a bicycle into a nonwoven bag can accomplish the object of carrying, but it cannot protect the stowed bicycle very well. Components and frame of the bicycle tend to be damaged if it collides with hard objects. Some existing main bags add a small-sized pad to protect the rear derailleur, which is the weakest part of a bicycle. However, the pad can provide very limited protection only, and it cannot protect the whole drivetrain system including a rear derailleur, chain, freewheel, crankset and front derailleur. The drivetrain is a very important portion of a bicycle. Especially in the crankset, sprockets tend to be deformed due to collision.

### SUMMARY OF THE INVENTION

An object of the invention is to provide a chain bag for a bicycle, which can completely and effectively protect a drivetrain system.

To accomplish the above object, the invention provides a chain bag. The chain bag is a rectangular bag with two hanging belts. The hanging belts are separately disposed with velcro fasteners for hanging on a frame of a bicycle.

### BRIEF DESCRIPTION OF THE DRAWINGS

FIG. 1 is a schematic view of the invention in use; and

FIG. 2 is a perspective view of the invention.

### DETAILED DESCRIPTION OF THE INVENTION

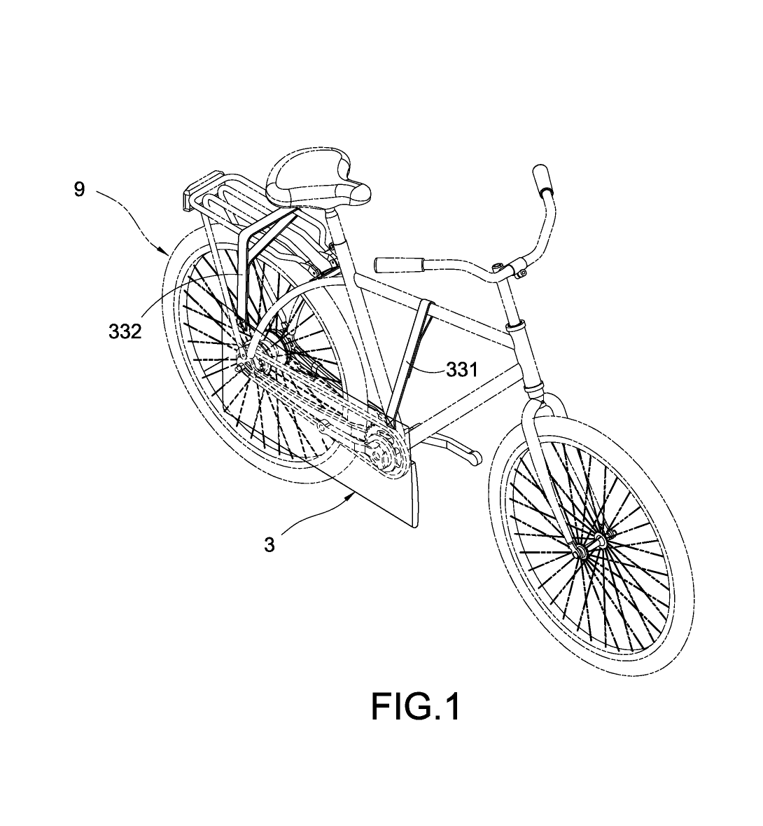

Please refer to FIG. 1. The invention is used in the instance when a bicycle 9 is stowed in a carrying bag. The invention provides a chain bag 3.

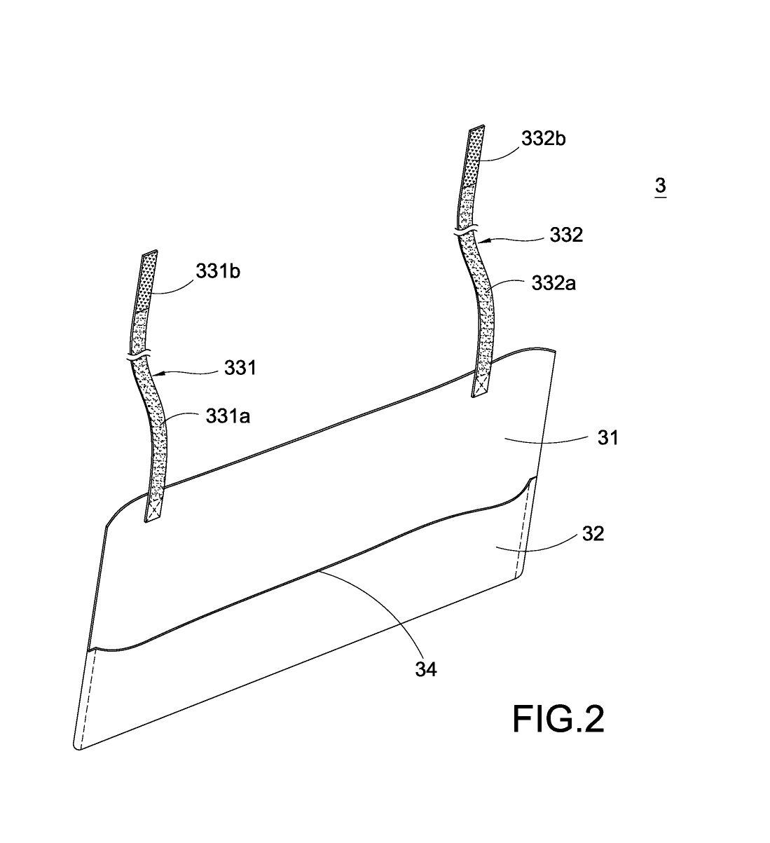

Please refer to FIG. 2. The chain bag 3 includes a main sheet 31, a secondary sheet 32 and two hanging belts 331, 332. The main sheet 31 and the secondary sheet 32 are of a substantially rectangular shape. The secondary sheet 32 is fastened on the main sheet 31 to form a bag body with an upward opening 34. The height of the secondary sheet 32 is lower than that of the main sheet 31. Preferably, the height of the secondary sheet 32 is about a half of that of the main sheet 31. And the secondary sheet 32 is located on a lower half of the main sheet 31.

The main sheet 31 is substantially the same as the secondary sheet 32 in width and the width is slightly greater than the whole width of the drivetrain system composed of the sprocket, chain, freewheel, front derailleur and rear derailleur. The drivetrain system can be cloaked by the chain bag 3 in a bottom-up direction.

The two hanging belts 331, 332 are parallelly fastened to an upper edge of the main sheet 31 and extend upward. One side of each of the hanging belts 331, 332 is provided with a velcro fastener 331a, 331b; 332a, 332b. The velcro fastener 331a, 331b; 332a, 332b is composed of a hook patch 331b, 332b and a loop patch 331a, 332a. Each hanging belt 331, 332 is provided with a hook patch 331b, 332b and a loop patch 331a, 332a on the same side thereof and the hook patches 331b, 332b are separately located at outer ends of the hanging belts 331, 332, so that the outer end of each of the hanging belts 331, 332 will form a loop when the velcro fasteners 331a, 331b; 332a, 332b are turned and attached. The two loops formed by the hanging belts 331, 332 may loop up a top tube and rear wheel or rear rack of a bicycle 9 to secure the chain bag 3. The chain bag 3 can protect the bicycle drivetrain system when a bicycle 9 is being carried with a carrying bag.

It will be appreciated by persons skilled in the art that the above embodiment has been described by way of example only and not in any limitative sense, and that various alterations and modifications are possible without departure from the scope of the invention as defined by the appended claims.

What is claimed is:

1. A chain bag comprising:
a main sheet, being of a substantially rectangular shape;
a secondary sheet, being of a substantially rectangular shape, and fastened on the main sheet to form a bag body with an upward opening, wherein a height of the secondary sheet is lower than that of the main sheet, the secondary sheet is located on a lower portion of the main sheet; and
two hanging belts, parallelly fastened to an upper edge of the main sheet, and extending upward, wherein each of the hanging belts is provided with a velcro fastener so that an outer end of each of the hanging belt will form a loop when the velcro fastener is attached.

2. The chain bag of claim 1, wherein the height of the secondary sheet is about a half of that of the main sheet.

3. The chain bag of claim 1, wherein the main sheet is substantially the same as the secondary sheet in width.

4. The chain bag of claim 1, wherein each of the hanging belts is about 40-100 cm in length.

5. The chain bag of claim 4, wherein each of the hanging belts is about 60 cm in length.
